(19) United States
(12) Patent Application Publication
(10) Pub. No.: US 2012/0054117 A1
(43) Pub. Date: Mar. 1, 2012

(54) IDENTIFYING AN INDIVIDUAL IN RESPONSE TO A QUERY SEEKING TO LOCATE PERSONNEL WITH PARTICULAR EXPERIENCE

(76) Inventors: CHRISTOPHER PELTZ, Windsor, CO (US); Susan Spence, Cambridge (GB); Roger J. Steffen, Cupertino, CA (US); David Farrington Ludwig, Austin, TX (US)

(21) Appl. No.: 12/870,006

(22) Filed: Aug. 27, 2010

(51) Int. Cl. G06Q 10/00

(52) U.S. Cl. 705/320

(57) ABSTRACT

An information repository contains information regarding engagements, where the information regarding engagements specifies outcomes of the engagements and roles of individuals involved in the engagements. In response to a query seeking to locate personnel with particular experience, at least one of the individuals is identified based on the information regarding engagements, where the identifying considers the roles of the individuals in the outcomes of the engagements.

### BACKGROUND

When working on projects within an enterprise (e.g., a company, educational organization, government agency, etc.), it is often useful to consult people who have had relevant past experience. However, finding personnel with the appropriate experience can be difficult and inefficient.

### BRIEF DESCRIPTION OF THE DRAWINGS

Some embodiments are described with respect to the following figures:

FIGS. 1 and 2 are flow diagrams of processes of identifying an individual that considers roles of individuals in outcomes of engagements, in accordance with some embodiments; and

FIG. 3 is a block diagram of a system incorporating some embodiments.

### DETAILED DESCRIPTION

When working on a particular engagement, it is often desirable to locate people who have been involved in similar engagements in the past who can offer advice, answer questions, and so forth. An “engagement” refers to an activity or collection of activities to accomplish a particular goal (such as to develop a product, implement a procedure, analyze information, solve a problem, develop a plan, generate a report, and so forth). An example of an engagement is a project in which personnel is involved to accomplish the goal of the project. A “project” is a defined undertaking assigned by an enterprise (e.g., company, educational organization, government agency, etc.) to produce a desired result. In the ensuing discussion, techniques or mechanisms according to some embodiments are discussed in the context of projects. However, techniques or mechanisms according to some embodiments can also be applied to other types of engagements that are less formally defined than projects.

To find people who may have similar experience, individuals involved in a project may attempt to connect with other people they know. Alternatively, individuals may attempt to perform a search to find such people, such as by performing an online search of a variety of information sources that are publicly available, that are available within a particular enterprise, or that are available to subscribers of social or professional networking sites. However, such attempts at locating people who may have relevant past experience is performed in an ad-hoc manner and thus may not reliably identify the best personnel with relevant experience.

Techniques or mechanisms according to some embodiments consider more relevant information in identifying people who have particular experience that can assist individuals of a current project. In some examples, the information considered in performing the identification of people with relevant experience include information relating to the profiles of people, information about past projects, and information relating to outcomes of projects. Rather than merely looking at a given person's profile at a given time to consider whether the person would be a useful resource for a particular project, techniques or mechanisms according to some implementations take into account the role of such person in an outcome of a project.

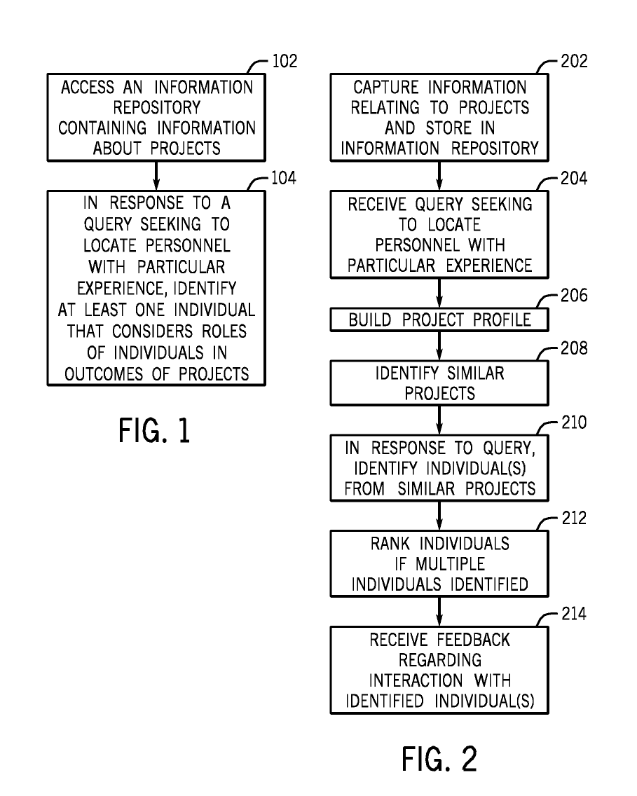

Generally, FIG. 1 depicts a process performed by a personnel location system according to some implementations. The personnel location system accesses (at 102) an information repository containing information regarding projects, where the information regarding projects specifies outcomes of the projects and roles of individuals involved in the projects. A query can be submitted by users seeking to locate personnel with particular experience. Examples of queries seeking to locate personnel with particular experience can include the following. One example query can seek individuals who have worked as project managers on projects that involved migration of a particular type of system and that completed on time and under budget. Another example query can seek individuals in an enterprise who may have interacted with customers similar to the customers associated with a current project, and who may have success with such types of customers. Another example query can seek individuals involved in projects similar to a current project, where such similar projects had experienced a particular outcome.

In response to the received query, the personnel location system identifies (at 104), based on the information regarding the projects, at least one of the individuals, where the identifying considers the roles of the individuals in the outcomes of the projects. The success of a particular project can be based on various different success criteria. The success of a project for any given criterion can be influenced by certain roles. For example, a project manager may have direct influence on the success of a project based on a time criterion and/or budget criterion, since the project manager is able to control resources allocated to the project; the project is considered a success if the project came in on time and within budget. On the other hand, an architect, who has a different role in the project, may have more influence on whether the project successfully aligned with the architectural standards of an enterprise (in other words, the success of the project in this regard is based on whether or not the project is aligned with the architectural standards for the enterprise). Thus, an architect involved in a particular project may not have had a direct role in the particular project completing in time and under budget. Similarly, a marketing person in the particular project may not have had a direct role in the particular project being successfully aligned with architectural standards of the organization. By being able to identify individuals that considers roles of the individuals in the outcomes of the projects, techniques or mechanisms according to some implementations are more likely to be able to identify relevant personnel who can assist in a current project. For example, if a query is seeking an individual in a past project who contributed to the successful architectural design of a system, then identifying the marketing person in such past project would not be a useful result—rather, it would be more useful if the architect of such past project be identified.

The outcome of each project can be represented by a set of attributes. Thus, identifying one or multiple individuals that satisfy a query seeking to locate personnel with particular experience considers values of such attributes in the set. A combination of the values of each set of attributes provides a measure of success of the corresponding project. Each set of attributes includes at least one attribute selected from among the following (as examples): an attribute relating to timeliness in completing the corresponding project, an attribute indicating a cost of the corresponding project (e.g., indicating if the corresponding project was completed under budget), and an attribute relating to quality in performance of the project. For example, the attribute relating to quality can be a measure based on the number of defects or issues recorded but not resolved in the particular project. In other examples, other measures of quality can be used.

The personnel location system according to some implementations is also able to consider roles of individuals as the roles change over time. When an individual first joined an enterprise, the individual may have had a first type of role. However, over time, as the individual is reassigned to different projects and/or promoted, the roles of the individual would have changed over time. In identifying an individual with a particular role in an outcome of a project, the personnel location system according to some implementations considers the individual's role at the time that the project had the target outcome. Note that even within a project, an individual may have multiple roles. It may be useful to consider the particular role of the individual at the time that the target outcome occurred. Alternatively or additionally, the personnel location system according to some implementations can consider the freshness of an individual's roles—a more recent role may be weighted more heavily than a least recent role of the individual. Thus, freshness of the individual's roles can be considered in identifying the individual in response to a query seeking to locate personnel with particular experience.

FIG. 2 is a flow diagram of a process according to further implementations to locate personnel with particular experience. Initially, information relating to projects (past projects and current projects) and personnel within the projects is captured (at 202) by the personnel location system and stored in an information repository. The information captured can be from various sources, which can include tools that are designed to collect project information. Such tools can capture information regarding the skill set of an individual, a number of projects managed by the individual, the scope of each project, and the actual outcome (or expected outcome), as examples. Information can also be captured from other information sources, such as user profiles maintained on the web, information kept in databases maintained by an enterprise, social or professional networking sites, archived e-mail messages, and so forth.

The capture of information relating to projects and personnel (202) is performed on a continual manner. The information repository can be updated as projects are updated or completed, and as other information sources such as user profiles are updated.

The personnel location system is able to receive (at 204) a query seeking to locate personnel with particular experience. The query can be submitted by someone from a current project, and the query can specify or point to information relating to the current project. Based on the information relating to the current project associated with the query, the personnel location system builds (at 206) a project profile (or project template) to define characteristics of the current project. The project profile allows the personnel location system to find other similar projects such that appropriate personnel involved in such similar projects can be identified.

The personnel location system uses a project similarity technique to identify (at 208) projects that are similar to the current project (that is associated with the received query). The project profile built at 206 can specify specific characteristics of the project such as the name of the project, project outcome, current phase of the project, and other characteristics. The project characteristics can be used for identifying other projects that are similar to the project of interest (based on comparison of the project characteristics). Depending on the objective, similarity of projects can be defined in different ways. For example, projects relating to implementation of database management software and business management software can be similar from the standpoint that they are both software upgrades, but they can also be quite different given they are targeted at different environments.

Note that the information repository may not contain direct, explicit classifications of a project (e.g., the project is of type “X”). To address this, documentation or other artifacts can be mined to derive a set of keywords or association types for a project. For example, a project may have information recorded that indicates that it is related to a business software upgrade.

In some examples, project similarity techniques as described in PCT Application No. PCT/US10/30518, entitled “Method and System for Comparing and Locating Projects,” filed Apr. 9, 2010, can be used to find similar projects. The project similar techniques of PCT/US10/30518 extract features of projects being compared, where the features can be extracted from project profiles (including the project profile built at 206). The features for the projects are provided to corresponding feature comparators, which output respective feature-similarity values. The outputs from feature comparators are weighted and aggregated by a feature-similarity aggregator(s) to produce a final project-similarity value, which is used to provide a measure of the relative similarity of the compared projects. Further details regarding such project similarity techniques are provided in PCT/US10/30518.

In other implementations, other techniques for finding similar projects can be used.

Once similar projects have been identified, the personnel location system identifies (at 210) individuals involved in such identified similar projects, where the identification of individuals considers roles of such individuals in outcomes of the projects.

In some cases, an individual's role(s) in the corresponding project(s) can be explicitly specified. In other words, an explicit role name is assigned to the individual in a specific capacity. Alternatively, a role inferencing technique can be applied to infer a role of a particular individual based on activities of the particular individual. For example, a Java developer can be inferred based on a number of form discussion postings made by the individual containing Java and related keywords.

If multiple individuals are identified as satisfying a query seeking to locate personnel with particular experience, such multiple individuals may be ranked (at 212) and sorted by a similarity criterion. The ranking can also take into account current employment status of personnel—in processing the query to locate personnel, certain individuals may percolate to the top as good candidates, but such individuals may not be currently reachable, such as due to the individuals no longer being employed by a given enterprise.

The identifiers of the individuals and their respective ranking measures can be presented to a requestor who submitted the query. Once the requestor is provided with the identifier(s) of the one or multiple individuals that satisfy the query, the requestor can contact the identified individual(s) (e.g., one or multiple ones of the highest ranked individuals) directly to ask questions or to learn from their experiences.

Ranking of identified multiple individuals can be ranking by similarity of past held roles, ranking by similarity of past projects, ranking by degree of success as measured by a cost, time, and/or quality attribute, ranking by freshness (when the individual held similar roles), or other attributes.

In some implementations, the requestor can rate their interactions with the identified individual(s). The rating(s) may be based on helpfulness of the individual(s). The rating(s) can be received (at 214) by the personnel location system and stored in the information repository to allow use as feedback to assist in future searches for individuals. For example, a rating that an identified individual was not particularly helpful may be used in future searches to possibly rank this particular individual lower when this individual is again identified. The rating that is applied can be in the context of a particular project activity. For example, if the particular project activity is development of a system architecture, then the rating can indicate whether the identified individual was able to provide useful advice regarding architectural designs.

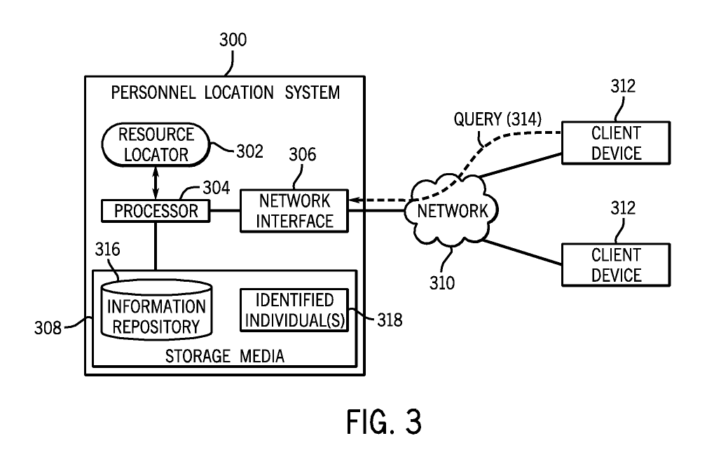

FIG. 3 illustrates an example arrangement that incorporates some embodiments. The example arrangement includes a personnel location system 300 having a resource locator 302 executable on one or multiple processors 304. The resource locator 302 is able to perform the tasks of FIG. 1 or 2 (and/or other tasks discussed above) for identifying at least one individual in response to a query seeking to locate personnel with particular experience. The processor(s) 304 is (are) connected to a network interface 306 and storage media 308. The network interface 306 allows the personnel location system 300 to communicate over a data network 310, which is coupled to client devices 312. A client device 312 can submit a query (314) to the system to locate personnel with particular experience.

The storage media 308 stores an information repository 316, which can contain information regarding various projects, where the information regarding the various projects specifies outcomes of the projects and roles of individuals involved in the projects. In addition, the storage media 308 can also store information generated by the resource locator 302 regarding identified individual(s) in response to the query (314). The information 318 can be sent by the resource locator 302 through the network interface 306 over the network 310 to the requesting client device 312.

The resource locator 302 can be implemented with machine-readable instructions that are loaded for execution on the processor(s) 204. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
accessing, by a system having a processor, an information repository containing information regarding engagements, wherein the information regarding engagements specifies outcomes of the engagements and roles of individuals involved in the engagements; and
in response to a query seeking to locate personnel with particular experience, identifying, by the system based on the information regarding engagements, at least one of the individuals, wherein the identifying considers the roles of the individuals in the outcomes of the engagements.

2. The method of claim 1, wherein the identifying considers the roles of the individuals over time, and wherein identifying the at least one individual is based on the role of the at least one individual in the corresponding engagement at the time a particular outcome occurred.

3. The method of claim 1, wherein the identified at least one individual has multiple roles over time, and wherein the identifying places greater weight in a more recent role of the identified at least one individual.

4. The method of claim 1, wherein the query seeks to locate personnel with the particular experience in a particular type of engagement, and wherein the identifying further considers information in the information repository regarding types of the engagements to find engagements in the information repository similar to the particular type of engagement.

5. The method of claim 4, further comprising:
deriving a classification of a type of a particular one of the engagements in the information repository based on mining information associated with the engagements represented in the information repository.

6. The method of claim 1, wherein the outcome of each of the engagements is represented by a set of attributes, and wherein the identifying that considers the outcomes of the engagements is based on values of each of the sets of the attributes, wherein a combination of the values of each set of the attributes provides a measure of success of the corresponding engagement.

7. The method of claim 6, wherein each set of attributes includes at least one attribute selected from among: an attribute relating to timeliness in completing the corresponding engagement, an attribute indicating a cost of the corresponding engagement, and an attribute relating to quality.

8. The method of claim 1, wherein identifying the at least one individual comprises identifying plural individuals, the method further comprising:
ranking the identified plural individuals.

9. The method of claim 1, further comprising:
applying a role inferencing technique to infer a role of a particular individual based on activities of the particular individual; and
storing the inferred role in the information repository.

10. The method of claim 1, further comprising:
receiving feedback information regarding interaction with the identified at least one individual; and
providing the feedback information to the information repository to use for providing a response to a subsequent query seeking to locate personnel with particular experience.

11. The method of claim 1, wherein accessing the information repository containing information regarding engagements comprises accessing the information repository containing information regarding projects.

12. An article comprising at least one machine-readable storage medium storing instructions that upon execution cause a system having a processor to:
receive, from a requestor associated with a particular project, a query seeking to locate personnel with particular experience;
identify, in response to the query and based on accessing an information repository containing information regarding projects, similar projects to the particular project; and
identify at least one individual from the similar projects, wherein the identifying considers the roles of individuals in the similar projects in outcomes of the corresponding similar projects.

13. The article of claim 12, wherein identifying the similar projects is based on comparing project attributes of the particular project and project attributes of the projects in the information repository.

14. The article of claim 12, wherein the outcome of each of the projects in the information repository is represented by a set of attributes, and wherein the identifying of the at least one individual that considers the outcomes of the projects is based on values of each of the sets of the attributes, wherein a combination of the values of each set of the attributes provides a measure of success of the corresponding project.

15. The article of claim 14, wherein each set of attributes includes at least one attribute selected from among: an attribute relating to timeliness in completing the corresponding project, an attribute indicating a cost of the corresponding project, and an attribute relating to quality.

16. The article of claim 12, wherein identifying the at least one individual comprises identifying plural individuals, the instructions upon execution causing the system to further:
rank the identified plural individuals; and
output identifiers of the plural individuals along with respective ranking measures to the requestor.

17. The article of claim 12, wherein the instructions upon execution causing the system to further:
receive feedback information regarding interaction with the identified at least one individual; and
provide the feedback information to the information repository to use for providing a response to a subsequent query seeking to locate personnel with particular experience.

18. A system comprising:
a storage media to store an information repository containing information regarding engagements, wherein the information regarding engagements specifies outcomes of the engagements and roles of individuals involved in the engagements; and
at least one processor to:
receive a query seeking to locate personnel with particular experience; and
in response to the query, identify, based on the information regarding engagements, at least one of the individuals, wherein the identifying considers the roles of the individuals in the outcomes of the engagements.

19. The system of claim 18, wherein the query is associated with a particular engagement, and wherein the at least one processor is to:
identify selected engagements from the information repository that are similar to the particular engagement,
wherein identification of the at least one individual is from the selected similar engagements.
